(19) United States
(12) Patent Application Publication
(10) Pub. No.: US 2020/0264005 A1
(43) Pub. Date: Aug. 20, 2020

(54) ELECTRONIC APPARATUS AND CONTROLLING METHOD THEREOF

(71) Applicant: Samsung Electronics Co., Ltd., Suwon-si (KR)

(72) Inventors: Kyuho HEO, Suwon-si (KR); Byeonghoon KWAK, Suwon-si (KR); Daedong PARK, Suwon-si (KR)

(21) Appl. No.: 16/793,316

(22) Filed: Feb. 18, 2020

(30) Foreign Application Priority Data
Feb. 19, 2019 (KR) 10-2019-0019485

(51) Int. Cl. G01C 21/36; G06K 9/62; G06K 9/00; G06F 3/16

(52) U.S. Cl. CPC G01C 21/3602; G06K 9/6256; G01C 21/3629; G06K 9/00637; G06F 3/165; G06K 9/00791

(57) ABSTRACT

An electronic apparatus and a controlling method thereof are provided. The electronic apparatus includes a camera, a sensor, an output interface including circuitry, and a processor configured to, based on information regarding objects existing on a route to a destination of the vehicle, output guidance information regarding the route through the output interface. The information regarding objects is obtained from a plurality of trained models corresponding to a plurality of sections included in the route based on location information of the vehicle obtained through the sensor and an image obtained by imaging a portion ahead of the vehicle obtained through the camera.

### CROSS-REFERENCE TO RELATED APPLICATION(S)

This application is based on and claims priority under 35 U.S.C. § 119(a) of a Korean patent application number 10-2019-0019485, filed on Feb. 19, 2019, in the Korean Intellectual Property Office, the disclosure of which is incorporated by reference herein in its entirety.

### BACKGROUND

### 1. Field

The disclosure relates to an electronic apparatus and a controlling method thereof. More particularly, the disclosure relates to an electronic apparatus that guides a user to a route and a controlling method thereof.

### 2. Description of the Related Art

Along the development of electric technologies, a technology of guiding a route from a location of a user to a destination, in order to guide a user to a route, has been recently popularized.

Particularly, in order to improve user experience (UX), a route guidance according to buildings (or company names) may be provided. For this, it is necessary to construct map data regarding buildings (or company names) in a database in advance.

However, as the sizes of the regions increase, an amount of map data to be stored increases, and when a building as a reference of the route guidance is reconstructed or the name of company is changed, the map data stored in the database had to be changed.

The reference of the route guidance may be a building with a high visibility, but the visibility varies depending on users (e.g., a tall user, a short user, a red-green color blind user, or the like), weather (e.g., snow, fog, or the like), time (e.g., day, night, or the like), and thus the reference may not be uniformly determined.

Meanwhile, a building to be a reference of the route guidance may be determined depending on situations in a view of a user, by capturing an image in real time, inputting the captured image to an artificial intelligence (AI) model, and processing the image in real time. However, in a case of using an artificial intelligence model, as the size of the region increases, an operation speed and accuracy are significantly decreased and a size of a trained model may significantly increase.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus capable of more conveniently and easily guiding a user to a route and a controlling method thereof.

Additional aspects will be set forth in part in the description which follows and, in part, will be apparent from the description, or may be learned by practice of the presented embodiments.

In accordance with an aspect of the disclosure, an electronic apparatus included in a vehicle is provided. The electronic apparatus includes a camera, a sensor, an output interface including circuitry, and a processor configured to, based on information regarding objects existing on a route to a destination of the vehicle, output guidance information regarding the route through the output interface, and the information regarding objects is obtained from a plurality of trained models corresponding to a plurality of sections included in the route based on location information of the vehicle obtained through the sensor and an image obtained by imaging a portion ahead of the vehicle obtained through the camera.

In accordance with another aspect of the disclosure, a controlling method of an electronic apparatus included in a vehicle is provided. The controlling method includes, obtaining information regarding objects existing on a route from a plurality of trained models corresponding to a plurality of sections included in the route to a destination of the vehicle based on location information of the vehicle and an image obtained by imaging a portion ahead of the vehicle, and outputting guidance information regarding the route based on the information regarding the objects existing on the route to the destination of the vehicle.

According to various embodiments of the disclosure described above, an electronic apparatus capable of more conveniently and easily guiding a user to a route and a controlling method thereof may be provided.

According to various embodiments of the disclosure, an electronic apparatus capable of guiding a route with respect to an object depending on situations in a view of a user, and a controlling method thereof may be provided. In addition, a service with improved user experience (UX) regarding the route guidance may be provided to a user.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing a system according to an embodiment of the disclosure;

FIG. 2 is a diagram for describing a method for training a model according to learning data according to an embodiment of the disclosure;

FIG. 3 is a block diagram for describing a configuration of an electronic apparatus according to an embodiment of the disclosure;

FIG. 4 is a diagram for describing an electronic apparatus according to an embodiment of the disclosure;

FIG. 5 is a diagram for describing a method for determining an object according to an embodiment of the disclosure;

FIGS. 6A, 6B, and 6C are block diagrams showing a learning unit and a recognition unit according to various embodiments of the disclosure;

FIG. 7 is a block diagram specifically showing a configuration of an electronic apparatus according to an embodiment of the disclosure; and

FIG. 8 is a diagram for describing a flowchart according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be noted that the technologies disclosed in this disclosure are not for limiting the scope of the disclosure to a specific embodiment, but they should be interpreted to include all modifications, equivalents or alternatives of the embodiments of the disclosure. In relation to explanation of the drawings, similar drawing reference numerals may be used for similar elements.

The expressions “first,” “second” and the like used in the disclosure may denote various elements, regardless of order and/or importance, and may be used to distinguish one element from another, and does not limit the elements.

In the disclosure, expressions such as “A or B”, “at least one of A [and/or] B,”, or “one or more of A [and/or] B,” include all possible combinations of the listed items. For example, “A or B”, “at least one of A and B,”, or “at least one of A or B” includes any of (1) at least one A, (2) at least one B, or (3) at least one A and at least one B.

Unless otherwise defined specifically, a singular expression may encompass a plural expression. It is to be understood that the terms such as “comprise” or “consist of” are used herein to designate a presence of characteristic, number, operation, element, part, or a combination thereof, and not to preclude a presence or a possibility of adding one or more of other characteristics, numbers, operations, elements, parts or a combination thereof.

If it is described that a certain element (e.g., first element) is “operatively or communicatively coupled with/to” or is “connected to” another element (e.g., second element), it should be understood that the certain element may be connected to the other element directly or through still another element (e.g., third element). On the other hand, if it is described that a certain element (e.g., first element) is “directly coupled to” or “directly connected to” another element (e.g., second element), it may be understood that there is no element (e.g., third element) between the certain element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the expression “configured to” does not necessarily mean that a device is “specifically designed to” in terms of hardware. Instead, under some circumstances, the expression “a device configured to” may mean that the device “is capable of” performing an operation together with another device or component. For example, the phrase “a processor configured (or set) to perform A, B, and C” may mean a dedicated processor (e.g., an embedded processor) for performing the corresponding operations, or a generic-purpose processor (e.g., a central processing unit (CPU) or an application processor) that can perform the corresponding operations by executing one or more software programs stored in a memory device.

An electronic apparatus according to various embodiments of the disclosure may include at least one of, for example, a smartphone, a tablet personal computer (PC), a mobile phone, a video phone, an e-book reader, a desktop personal computer (PC), a laptop personal computer (PC), a netbook computer, a workstation, a server, a personal digital assistant (PDA), a portable multimedia player (PMP), an moving picture experts group (MPEG-1 or MPEG-2) audio layer 3 (MP3) player, a mobile medical device, a camera, or a wearable device. According to various embodiments, a wearable device may include at least one of an accessory type (e.g., a watch, a ring, a bracelet, an ankle bracelet, a necklace, a pair of glasses, a contact lens or a head-mounted-device (HMD)); a fabric or a garment-embedded type (e.g.: electronic cloth); skin-attached type (e.g., a skin pad or a tattoo); or a bio-implant type (implantable circuit).

In addition, in some embodiments, the electronic apparatus may be home appliance. The home appliance may include at least one of, for example, a television, a digital video disc (DVD) player, an audio system, a refrigerator, air-conditioner, a vacuum cleaner, an oven, a microwave, a washing machine, an air purifier, a set top box, a home automation control panel, a security control panel, a media box (e.g., SAMSUNG HOMESYNC™, APPLE TV™, or GOOGLE TV™), a game console (e.g., XBOX™, PLAYSTATION™), an electronic dictionary, an electronic key, a camcorder, or an electronic frame.

In other embodiments, the electronic apparatus may include at least one of a variety of medical devices (e.g., various portable medical measurement devices such as a blood glucose meter, a heart rate meter, a blood pressure meter, or a temperature measuring device), magnetic resonance angiography (MRA), magnetic resonance imaging (MRI), or computed tomography (CT) scanner, or ultrasonic wave device, etc.), a navigation system, a global navigation satellite system (GNSS), an event data recorder (EDR), a flight data recorder (FDR), an automotive infotainment device, a marine electronic equipment (e.g., marine navigation devices, gyro compasses, etc.), avionics, a security device, a car head unit, industrial or domestic robots, an automated teller machine (ATM), a point of sale of (POS) a store, or an Internet of Things (IoT) device (e.g., light bulbs, sensors, electronic or gas meters, sprinkler devices, fire alarms, thermostats, street lights, toasters, exercise equipment, hot water tanks, heater, boiler, etc.).

According to another embodiment, the electronic apparatus may include at least one of a part of furniture or building/structure, an electronic board, an electronic signature receiving device, a projector, or various measurement devices (e.g., water, electric, gas, or wave measurement devices). In various embodiments, the electronic apparatus may be implemented as one of the various apparatuses described above or a combination of two or more thereof. The electronic apparatus according to a certain embodiment may be a flexible electronic apparatus. The electronic apparatus according to the embodiment of this document is not limited to the devices described above and may include a new electronic apparatus along the development of technologies.

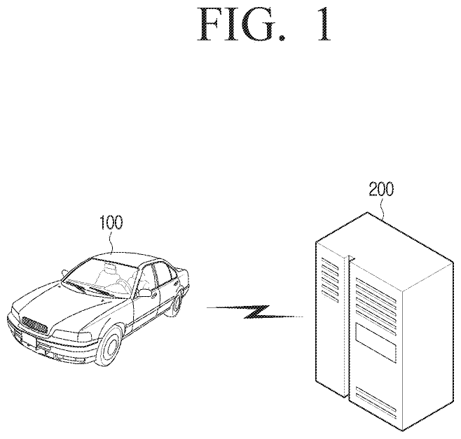

FIG. 1 is a diagram for describing a system according to an embodiment of the disclosure.

Referring to FIG. 1, a system of the disclosure may include an electronic apparatus 100 and a server 200.

As shown in FIG. 1, the electronic apparatus 100 may be embedded in a vehicle as an apparatus integrated with the vehicle or combined with or separated from the vehicle as a separate apparatus. The vehicle herein may be implemented as various transportations such as a car, a motorcycle, a bicycle, a robot, a train, a ship, or an airplane, as travelable transportation. In addition, the vehicle may be implemented as a travelling system applied with a self-driving system or advanced driver assistance system (ADAS). Hereinafter, the description will be made assuming that the vehicle as a car as shown in FIG. 1, for convenience of description.

An electronic apparatus 100, as an apparatus capable of guiding a user of a vehicle to a route to a destination of the vehicle, may transmit and receive various types of data by executing various types of communication with the server 200, and synchronize data in real time by interworking with the server 200 in a cloud system or the like.

The server, as an external electronic apparatus capable of executing communication in various systems, may transmit, receive, or process various types of data, in order to guide a user of the electronic apparatus 100 to a route to a destination of a vehicle.

For this, the server 200 may include a communication interface (not shown) and, for the description regarding this, a description regarding a communication interface 150 of the electronic apparatus 100 which will be described later may be applied in the same manner.

The server 200 may be implemented as a single server capable of executing (or processing) all of various functions or a server system consisting of a plurality of servers designed to execute (or process) allocated functions.

In an embodiment, the external electronic apparatus may be implemented as a cloud server (200) providing resources for information technology (IT) virtualized on the Internet as service or an edge server simplifying a route of data in a system of processing data in real time in a close range to a place where data is generated, or a combination thereof.

In another embodiment, the server 200 may include a server device designed to collect data using crowdsourcing, a server device designed to collect and provide map data for guiding a route of a vehicle, or a server device designed to process an artificial intelligence (AI) model.

The electronic apparatus 100 may guide a user of a vehicle to a route to a destination of the vehicle.

Specifically, when the electronic apparatus 100 receives a user command for setting a destination, the electronic apparatus 100 outputs guidance information regarding a route to a destination from a location of the vehicle searched based on location information of the vehicle and information regarding a destination.

For example, when a user command for setting a destination is received, the electronic apparatus 100 may transmit location information of a vehicle and information regarding a destination to the server 200, receives guidance information regarding a searched route from the server 200, and output the received guidance information.

The electronic apparatus 100 may output the guidance information regarding a route to a destination of the vehicle based on a reference object existing on the route to a user of the vehicle.

The reference object herein may be an object becoming a reference in the guiding of a user to a route, among objects such as buildings, company names, and the like existing on the route. For this, an object having highest discrimination (or visibility) which is distinguishable from other objects may be identified as the reference object among a plurality of objects existing in a view of a user.

For example, assuming that the reference object is a post office among the plurality of objects existing on the route, the electronic apparatus 100 may output guidance information regarding a route to a destination of a vehicle (e.g., turn right in front of the post office) to a user based on the reference object.

In addition, another object may be identified as the reference object depending on situations such as users (e.g., a tall user, a short user, a red-green color blind user, and the like), weather (e.g., snow, fog, and the like), time (e.g., day, night, or the like).

The electronic apparatus 100 of the disclosure may guide a route to a destination with respect to a user-customized object and improve user convenience and user experience regarding the route guidance.

The server 200 may store a plurality of trained models having determination criteria for determining an object having highest discrimination among the plurality of objects included in an image, in advance. The trained model may include one of artificial intelligence models and may mean a model designed to learn a particular pattern with a computer using input data and output result data like machine learning or deep learning. As an example, the trained model may be a nerve network model, a gene model, or a probability statistics model.

For example, the server 200 may store a plurality of models trained to identify an object having highest discrimination among objects included in images each captured according to avenues, weather, time, and the like, in advance. In addition, the plurality of trained models may be trained to identify an object having highest discrimination among objects included in the images by considering the height of a user or color weakness of a user.

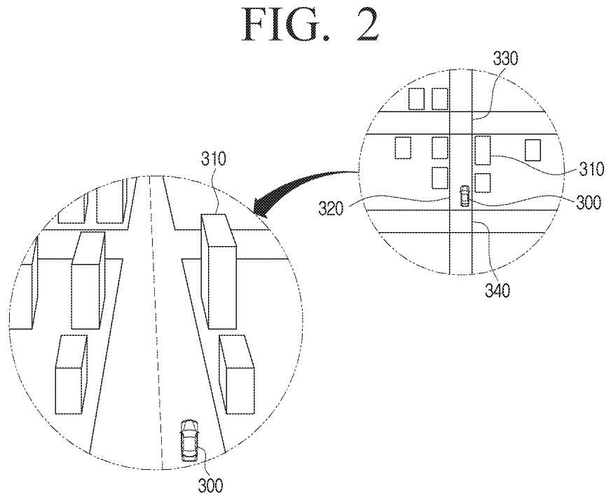

Hereinafter, a method for training a model according to learning data by the server 200 will be descried with reference to FIG. 2.

FIG. 2 is a diagram for describing a method for training a model according to learning data according to an embodiment of the disclosure.

Referring to FIG. 2, the server 200 may receive learning data obtained from a vehicle 300 for obtaining learning data. The learning data may include location information of a vehicle, an image obtained by imaging a portion ahead of the vehicle, and information regarding a plurality of objects included in the image. In addition, the learning data may include result information obtained by determining discrimination regarding the plurality of objects included in the image according to the time when the image captured, the weather, the height of a user, color weakness of a user, and the like.

Here, the vehicle 300 for obtaining learning data may obtain the image obtained by imaging a portion ahead of the vehicle 300 and information of location where the image is captured. For this, the vehicle 300 for obtaining learning data may include a camera (not shown) and a sensor (not shown), and for these, descriptions regarding a camera 110 and a sensor 120 of the electronic apparatus 100 of the disclosure which will be described later may be applied in the same manner.

When the learning data is received from the vehicle 300 for obtaining learning data, the server 200 may train or update the plurality of models having determination criteria for determining an object having highest discrimination among the plurality of objects included in an image using the learning data. The plurality of models may include a plurality of models designed to have a predetermined region for each predetermined distance as a coverage or designed to have a region of an avenue unit as a coverage.

In an embodiment, each of the plurality of models may be a model trained based on an image captured in each of the plurality of sections of the avenue divided with respect to intersections. In the following description, it is assumed that the plurality of models are a plurality of models such as models 1-a, 1-b, and 1-c.

For example, as shown in FIG. 2, it is assumed that a model 1-A has a first section 320 of the avenue with respect to the intersection as a coverage. The first section 320 herein may mean an avenue connecting a first intersection 330 and a second intersection 340.

In this case, the model 1-A may be trained using an image obtained by imaging a portion ahead of the vehicle 300 for obtaining learning data in the first section 320 divided with respect to the intersection as the learning data. At this time, in order to use the image as the learning data (or input data) of the model, a feature extraction process of converting an image to one feature value corresponding to a point in an n-dimensional space (n is a natural number) may be performed.

In addition, the model 1-A may use result information obtained by determining a post office building 310 as an object having highest discrimination in advance among the plurality of objects included in the image obtained by imaging a portion ahead of the vehicle 300 for obtaining learning data, as learning data, and may be trained so that result information obtained by determining the object having highest discrimination among the plurality of objects included in the image and the predetermined result information coincide with each other. At this time, the determined result information output by the model may include information regarding the plurality of objects included in the image and information regarding possibility to be discriminated at a particular location among the plurality of objects.

As described above, the model 1-A may have the first section 320 of the avenue as a coverage. That is, the model 1-A may be trained using the image captured in the first section 320 by the vehicle 300 for obtaining learning data and, when the image captured in the first section 320 is input by the electronic apparatus 100, the model may output result information obtained by determining an object having highest discrimination among the plurality of objects included in the input image.

In another embodiment, each of the plurality of models may include model trained based on an image captured at a particular location and environment information. The environment information may include information regarding time when an image is captured, weather, the height of a user, color weakness of a user.

Regarding an image captured at a particular location of the first section 320 of the same avenue as in the example described above, an object having highest discrimination among the plurality of objects included in the image may vary depending on time when the image is captured, weather, the height of a user, color weakness of a user.

For example, a model 1-B may be trained using an image obtained by imaging a portion ahead of the vehicle 300 for obtaining learning data in the first section 320 at night and result information obtained by determining an object at night as the learning data. As another example, in a case where a user has color weakness, a model 1-C may be trained using an image obtained by imaging a portion ahead of the vehicle 300 for obtaining learning data and result information obtained by determining an object based on a user having color weakness as the learning data.

According to various embodiments of the disclosure hereinabove, an artificial intelligence model may be trained to identify an object suitable for a view of a user in various situations.

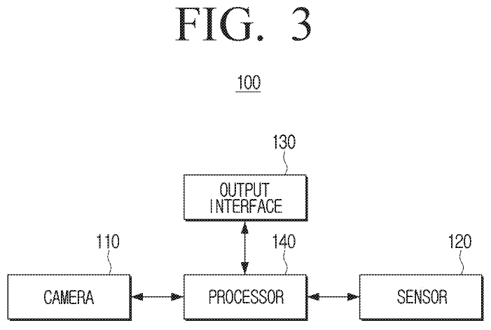

FIG. 3 is a block diagram for describing a configuration of the electronic apparatus according to an embodiment of the disclosure.

Referring to FIG. 3, the electronic apparatus 100 may include the camera 110, the sensor 120, an output interface 130, and a processor 140.

The camera 110 may obtain an image by capturing a specific direction or a space through a lens and obtain an image. In particular, the camera 110 may obtain an image obtained by imaging a portion ahead of the vehicle that is in a direction the vehicle travels. After that, the image obtained by the camera 110 may be transmitted to the server 200 or processed by an image processing unit (not shown) and displayed on a display (not shown).

The sensor 120 may obtain location information regarding a location of the electronic apparatus 100. For this, the sensor 120 may include various sensors such as a global positioning system (GPS), an inertial measurement unit (IMU), radio detection and ranging (RADAR), light detection and ranging (LIDAR), an ultrasonic sensor, and the like. The location information may include information for assuming a location of the electronic apparatus 100 or a location where the image is captured.

Specifically, the global positioning system (GPS) is a navigation system using satellites and may measure distances from the satellite and a GPS receiver and obtain location information by crossing the distance vectors thereof, and the IMU may detect a location change of an axis and/or a rotational change of an axis using at least one of an accelerometer, a tachometer, and a magnetometer, or a combination thereof, and obtain location information. For example, the axis may be configured with 3DoF or 6DoF, this is merely an example, and various modifications may be performed.

The sensors such as radio detection and ranging (RADAR), light detection and ranging (LIDAR), an ultrasonic sensor, and the like may emit a signal (e.g., electromagnetic wave, laser, ultrasonic wave, or the like), detect a signal returning due to reflection, in a case where the emitted signal is reflected by an object (e.g., a building, landmark, or the like) existing around the electronic apparatus 100, and obtain information regarding a distance between the object and the electronic apparatus 100, a shape of the object, features of the object, and/or a size of the object from an intensity of the detected signal, time, an absorption difference depending on wavelength, and/or wavelength movement.

In this case, the processor 140 may identify a matching object in map data from the obtained information regarding the shape of the object, the features of the object, the size of the object, and the like. For this, the electronic apparatus 100 (or memory (not shown) of the electronic apparatus 100) may store map data including the information regarding objects, locations, distances in advance.

The processor 140 may obtain location information of the electronic apparatus 100 using trilateration (or triangulation) based on the information regarding the distance between the object and the electronic apparatus 100 and the location of the object.

For example, the processor 140 may identify a point of intersections of first to third circles as a location of the electronic apparatus 100. At this time, the first circle may have a location of a first object as the center of the circle and a distance between the electronic apparatus 100 and the first object as a radius, the second circle may have a location of a second object as the center of the circle and a distance between the electronic apparatus 100 and the second object as a radius, and the third circle may have a location of a third object as the center of the circle and a distance between the electronic apparatus 100 and the third object as a radius.

In the above description, the location information has been obtained by the electronic apparatus 100, but the electronic apparatus 100 may obtain the location information by being connected to (or interworking with) the server 200. That is, the electronic apparatus may transmit the information (e.g., the distance between the object and the electronic apparatus 100, the shape of the object, features of the object, and/or the size of the object obtained by the sensor 120) required for obtaining the location information to the server 200, and the server 200 may obtain the location information of the electronic apparatus 100 based on the information received by executing the operation of the processor 140 described above and transmit the location information to the electronic apparatus 100. For this, the electronic apparatus 100 and the server 200 may execute various types of wired and wireless communications.

The location information may be obtained using the image captured by the camera 110.

Specifically, the processor 140 may recognize an object included in the image captured by the camera 110 using various types of image analysis algorithm (or artificial intelligence model or the like), and obtain the location information of the electronic apparatus 100 by the trilateration described above based on the size, location, direction, or angle of the object included in the image.

In one embodiment, the processor 140 may obtain a similarity by comparing the image captured by the camera 110 and a street view image, based on the street view (or road view) image captured in a direction, the vehicle travels, at each particular location of an avenue (or road) and map data including location information corresponding to the street view image, identify a location corresponding to the street view image having a highest similarity as a location where the image is captured, and obtain the location information of the electronic apparatus 100 in real time.

As descried above, the location information may be obtained by each of the sensor 120 and the camera 110, or a combination thereof. Accordingly, in a case where a vehicle such as a self-driving vehicle moves, the electronic apparatus 100 embedded in or separated from the vehicle may obtain the location information using the image captured by the camera 110 in real time. In the same manner as in the above description regarding the sensor 120, the electronic apparatus 100 may obtain the location information by being connected to (or interworking with) the server 200.

The output interface 130 has a configuration for outputting information such as an image, a map (e.g., roads, buildings, and the like), a visual element (e.g., an arrow, an icon or an emoji of a vehicle or the like) corresponding to the electronic apparatus 100 for showing the current location of the electronic apparatus 100 on the map, and guidance information regarding a route to which the electronic apparatus 100 is moving or is to move, and may obtain at least one circuit. The output information may be implemented in a form of an image or sound.

For example, the output interface 130 may include a display (not shown) and a speaker (not shown). The display may display an image data processed by the image processing unit (not shown) on a display region (or display). The display region may mean at least a part of the display exposed to one surface of a housing of the electronic apparatus 100. At least a part of the display is a flexible display and may be combined with at least one of a front surface region, a side surface region, a rear surface region of the electronic apparatus. The flexible display is paper thin and may be curved, bent, or rolled without damages using a flexible substrate. The speaker is embedded in the electronic apparatus 100 and may output various alerts or voicemails directly as sound, in addition to various pieces of audio data subjected to various process operations such as decoding, amplification, noise filtering, and the like by an audio processing unit (not shown).

The processor 140 may control overall operations of the electronic apparatus 100.

The processor 140 may output guidance information regarding a route based on information regarding objects existing on a route to a destination of a vehicle through the output interface 130. For example, the processor 140 may output the guidance information for guiding a route to a destination of a vehicle mounted with the electronic apparatus 100 through the output interface 130. The processor 140 may guide a route with respect to an object having a highest discriminability at the location of the vehicle, among the objects recognized by the image obtained by imaging a portion ahead of the vehicle mounted with the electronic apparatus 100. At this time, the discriminability may be identified by a trained model which is trained at the location of the vehicle among the plurality of trained models prepared for each section included in the route.

Here, the information regarding the object may be obtained from the plurality of trained models corresponding to a plurality of sections included in the route, based on the location information of the vehicle obtained through the sensor 120 and the image obtained by imaging a portion ahead of the vehicle obtained through the camera 110.

Each of the plurality of trained models may include a model trained to identify an object having highest possibility to be discriminated at a particular location among the plurality of objects included in the image, based on the image captured at the particular location. The particular location may mean a location where the image is captured and may be identified based on the location information of the vehicle (or the electronic apparatus 100) at the time when the image captured.

The object having highest possibility to be discriminated (or reference object) is a reference for guiding a user to the route, and may mean an object having highest discrimination (or visibility) which is distinguishable from other objects among the plurality of objects existing in a view of a user.

In this case, each of the plurality of trained models may include a model trained based on the image captured in each of the plurality of sections of the route divided with respect to intersections.

The plurality of sections may be divided with respect to intersections existing on the route. That is, each section may be divided with respect to the interfaces included in the route. In this case, the intersection is a point where the avenue is divided into several avenues and may mean a point (junction) where the avenues cross. For example, each of the plurality of sections may be divided as a section of the avenue connecting an intersection and another intersection.

The objects may include buildings existing on the route. That is, the objects may include buildings existing in at least one section (or peripheral portions of the section) included in the route to a destination of the vehicle among the plurality of sections divided with respect to the intersections.

The processor 140 may control the output interface 130 to output guidance information regarding at least one of a travelling direction and a travelling distance of a vehicle based on the buildings.

The guidance information may be generated based on information regarding the route, location information of the vehicle, and image from the server 200 in which the trained models for determining discriminability of the objects are stored. For example, the guidance information may be an audio type information for guiding a route with respect to a building such as “In 100 m, turn right at the post office” or “In 100 m, turn right after the post office”.

In this case, the processor 140 may control the output interface 130 to display image types of information for guiding a visual element (e.g., an arrow, an icon or an emoji of a vehicle or the like) corresponding to the vehicle showing the location of the vehicle on the map, roads, buildings, and the route based on the map data.

The processor 140 may output the guidance information through at least one of a speaker and a display. Specifically, the processor 140 may control a speaker to output the guidance information, in a case where the guidance information is an audio type, and may control a display to output the guidance information, in a case where the guidance information is an image type. In addition, the processor 140 may control the communication interface 150 to transmit the guidance information to an external electronic apparatus. And then the external electronic apparatus may output the guidance information.

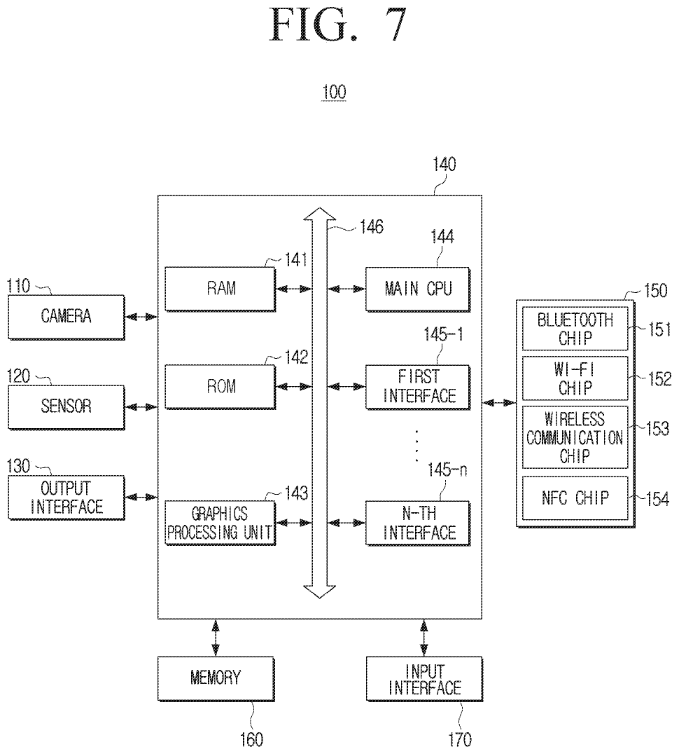

According to various embodiments of the disclosure, the electronic apparatus 100 may further include the communication interface 150 as shown in FIG. 7. The communication interface 150 has a configuration capable of transmitting and receiving various types of data by executing communication with various types of external device according to various types of communication system and may include at least one circuit.

In a first embodiment of the disclosure, the processor 140 may transmit the information regarding the route, the location information of the vehicle obtained through the sensor 120, and the image obtained by imaging a portion ahead of the vehicle obtained through the camera 110 to the server 200 through the communication interface 150, receive the guidance information from the server 200, and output the guidance information through the output interface 130. The server 200 may identify the plurality of trained models corresponding to the plurality of sections included in the route among the trained models stored in advance, obtain information regarding objects by using the image as input data of the trained model corresponding to the location information of the vehicle among the plurality of trained models, and obtain guidance information based on the information regarding objects.

Specifically, the processor 140 may receive a user command for setting a destination through an input interface (not shown).

The input interface has a configuration capable of receiving various types of user command such as touch of a user, voice of a user, or gesture of a user and transmitting the user command to the processor 140 and will be described later in detail with reference to FIG. 7.

When the user command for setting a destination is received through the input interface (not shown), the processor 140 may control the communication interface 150 to transmit the information regarding the route to the destination of the vehicle (or information regarding the destination of the vehicle), the location information of the vehicle obtained through the sensor 120, and the image obtained by imaging a portion ahead of the vehicle obtained through the camera 110 to the server 200.

In addition, the processor 140 may control the communication interface 150 to transmit environment information to the server 200. The environment information may include information regarding the time when the image captured, weather, a height of a user, color weakness of a user, and the like.

When the guidance information for guiding the route to the destination of the vehicle is received from the server 200 through the communication interface 150, the processor 140 may output the received guidance information through the output interface 130.

For this, the server 200 may identify the plurality of trained models corresponding to the plurality of sections included in the route among the trained models stored in advance.

Specifically, the server 200 may identify the route to the destination of the vehicle based on the information regarding the location of the vehicle and the route to the destination received from the electronic apparatus 100 and a route search algorithm stored in advance. The identified route may include intersections going through when the vehicle travels to the destination.

The route search algorithm may be implemented as A Star (A*) algorithm, Dijkstra's algorithm, Bellman-Ford algorithm, or Floyd algorithm for searching shortest travel paths, and may be implemented as an algorithm of searching shortest travel time by differently applying weights to sections connecting intersections depending on traffic information (e.g., traffic jam, traffic accident, road damage, or weather) to the above algorithm.

The server 200 may identify the plurality of trained models corresponding to the plurality of sections included in the identified route among the trained models stored in advance, based on the identified route. In this case, the server 200 may identify the plurality of trained models corresponding to the plurality of sections included in the identified route among the trained models stored in advance, based on the received environment information.

For example, in a case where the identified route includes a first section, the server 200 may identify model trained to have the first section as a coverage among the trained models stored in advance, as the trained model corresponding to the first section. In this case, the server 200 may identify the trained model corresponding to the environment information among the trained models stored in advance (or trained models corresponding to the first section).

The server 200 may obtain information regarding the objects by using the image received from the electronic apparatus 100 as input data of the trained model corresponding to the location information of the vehicle among the plurality of trained models. In addition, the server 200 may obtain information regarding the objects by using the received image as input data of the trained model corresponding to the environment information among the plurality of trained models.

The server 200 may obtain guidance information based on the information regarding objects and transmit the guidance information to the electronic apparatus 100.

Specifically, in order to use the image as the input data of the model, the server 200 may convert the image received from the electronic apparatus 100 to one feature value corresponding to a point in an n-dimensional space (n is a natural number) through a feature extraction process.

In this case, the server 200 may obtain the information regarding objects by using the converted feature value as the input data of the trained model corresponding to the location information of the vehicle among the plurality of trained models.

The server 200 may identify the object having highest discriminability (or reference object) among the plurality of objects included in the image, based on the information regarding objects obtained from each of the plurality of trained models. In this case, the information regarding objects may include a probability value (e.g., value from 0 to 1) regarding discrimination of the objects.

The server 200 may identify a map object matching with the reference object among a plurality of map objects included in the map data using location information of a vehicle and a field of view (FOV) of an image, based on the reference object having highest possibility to be discriminated included in the image. The field of view of the image may be identified depending on an angle of a lane included in the image. For this, the server 200 may store map data for providing the route to the destination of the vehicle in advance.

In this case, the server 200 may obtain information regarding the reference object (e.g., name, location, and the like of the reference object) from the map objects included in the map data matching with the reference object.

The server 200 may obtain the guidance information regarding the route (e.g., distance from the location of the vehicle to the reference object, direction in which the vehicle travels along the route with respect to the reference object, and the like) based on the location information of the vehicle and the reference object, and transmit the guidance information to the electronic apparatus 100.

For example, the server 200 may obtain the guidance information (e.g., “in 100 m, turn right at the post office”) by combining the information obtained based on the location and the destination information and the route search algorithm (e.g., “in 100 m, turn right”) and information regarding reference object obtained based on the image and the trained model (e.g., post office in 100 m), and transmit the guidance information to the electronic apparatus 100.

In this case, the server 200 may be implemented as a single device or may be implemented as a plurality of devices of a first server device configured to obtain information based on destination information and a route search algorithm, and a second server device configured to obtain information regarding objects based on an image and trained models.

In above-described embodiment, the server 200 has been obtained both the first guidance information and second guidance information, but the processor 140 of the electronic apparatus 100 may obtain the first guidance information based on the location, the destination, and the route search algorithm, and may output the guidance information by combining the first guidance information and the second guidance information, when the second guidance information obtained by the server 200 is received from the server 200.

In a second embodiment of the disclosure, the processor 140 may transmit information regarding a route to the server 200 through the communication interface 150, receive a plurality of trained models corresponding to a plurality of sections included in the route from the server 200, and obtain guidance information by using an image obtained by the camera 110 as input data of the trained model corresponding to the location information of the vehicle among the plurality of trained models.

Specifically, the processor 140 may transmit the information regarding a route to the server 200 through the communication interface 150.

In this case, the server 200 may identify the plurality of trained models corresponding to the plurality of sections included in the identified route among the trained models stored in advance based on the received information regarding a route, and transmit the plurality of trained models to the electronic apparatus 100. In this case, the server 200 may identify the plurality of trained models corresponding to the plurality of sections included in the identified route among the trained models stored in advance.

Here, the server 200 may transmit all or some of the plurality of trained models corresponding to the plurality of sections included in the route to the electronic apparatus 100 based on the location and/or travelling direction of the electronic apparatus 100. In this case, the server 200 may preferentially transmit a trained model corresponding to a section nearest to the location of the electronic apparatus 100 among the plurality of sections included in the route to the electronic apparatus 100.

For this, the processor 140 may control the communication interface 150 to periodically transmit the location information of the electronic apparatus 100 to the server 200 in real time or at each predetermined time.

When the plurality of trained models corresponding to the plurality of sections included in the route are received from the server 200, the processor 140 may obtain the guidance information by using the image as input data of the trained model corresponding to the location information of the vehicle among the plurality of trained models. For the description regarding this, a description regarding one embodiment of the disclosure may be applied in the same manner.

As described above, the electronic apparatus 100 may receive the plurality of trained models from the server 200 based on the information regarding the route and obtain the guidance information with respect to the objects using the image and the plurality of received trained models. After that, even in a case where the electronic apparatus 100 has moved, the electronic apparatus 100 may receive the plurality of trained models from the server 200 based on the location of the electronic apparatus 100, and obtain the guidance information with respect to objects using the image and the plurality of received trained models.

Accordingly, the electronic apparatus 100 of the disclosure may receive the plurality of trained models from the server 200 and process the image, instead of transmitting the image to the server 200, and thus, efficiency regarding the data transmission and processing may be improved.

All of the operations executed by the server 200 in the first and second embodiments described above may be modified and executed by the electronic apparatus 100. In this case, because it is not necessary to execute the operation of transmitting and receiving data to and from the server 200, the electronic apparatus 100 may only perform the operations except the operation of transmitting and receiving data among the operations of the electronic apparatus 100 and the server 200.

As described above, according to various embodiments of the disclosure, an electronic apparatus capable of guiding a route with respect to the object depending on situations in a view of a user and a controlling method thereof may be provided. In addition, a service with improved user experience (UX) regarding the route guidance may be provided to a user.

Hereinafter, the description will be made based on the first embodiment of the disclosure for convenience of description.

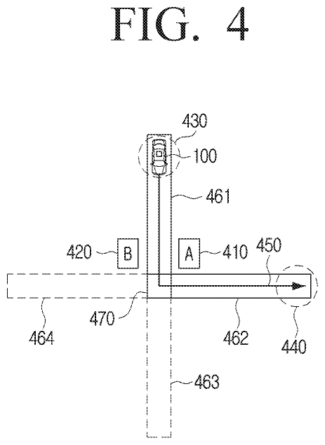

FIG. 4 is a diagram for describing the electronic apparatus according to an embodiment of the disclosure.

Referring to FIG. 4, it is assumed that a vehicle including the electronic apparatus 100 travels along a route 450 from a location 430 of the vehicle to a destination 440, and the route 450 includes a first section 461 and a second section 462 among a plurality of sections divided into the first section 461, the second section 462, a third section 463, and a fourth section 464 with respect to an intersection 470.

When a user command for setting the destination 440 is received through the input interface (not shown), the processor 140 may control the communication interface 150 to transmit the information regarding the destination 440 of the vehicle (or information regarding the route 450), the image obtained by imaging a portion ahead of the vehicle obtained through the camera 110, and the location information of the vehicle obtained through the sensor 120 to the server 200.

In this case, the server 200 may identify the plurality of trained models corresponding to the first and second sections 461 and 462 included in the route 450 among the trained models stored in advance based on the received information.

The server 200 may obtain information regarding an object A 410 and an object B 420 by using the image received from the electronic apparatus 100 as input data of the trained model corresponding to the first section 461 including the location 460 where the image is captured among the plurality of trained models.

In this case, the server 200 may identify an object having highest possibility to be discriminated at the particular location 430 among the object A 410 and the object B 420 included in the image, based on the information regarding the object A 410 and the object B 420 obtained from the trained model.

For example, in a case where a possibility value regarding the object A 410 is greater than a possibility value regarding the object B 420, the server 200 may identify the object having highest possibility to be discriminated among the object A 410 and the object B 420 included in the image as the object A 410.

In this case, the server 200 may obtain guidance information (e.g., In 50 m, turn left at the object A 410) obtained by combining the information regarding the object A 410 (e.g., In 50 m, object A 410) with the information obtained based on the location, the destination, and the route search algorithm (e.g., In 50 m, turn left).

When the guidance information obtained based on the information regarding the object A 410 existing on the route 450 to the destination 440 of the vehicle is received from the server 200, the processor 140 may control the output interface 130 to output the guidance information regarding the route.

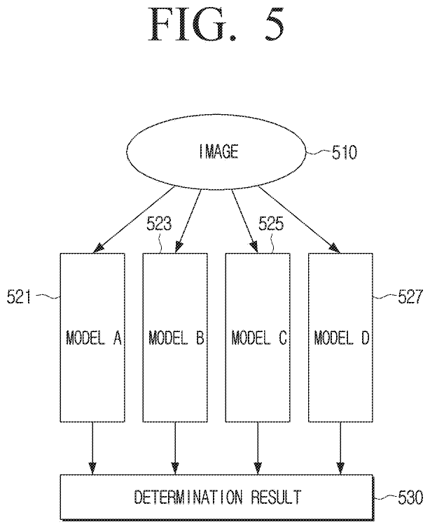

FIG. 5 is a diagram for describing a method for determining an object according to an embodiment of the disclosure.

Referring to FIG. 5, it is assumed that the route includes first to fourth sections among the plurality of sections divided with respect to intersections, an image 510 includes an object A and an object B as images captured in the first section included in the route among the plurality of sections, and trained models A 521, B 523, C 525 and D 527 are some of a plurality of trained models stored in the server 200 in advance.

In an embodiment, assuming that the trained models A 521, B 523, C 525, and D 527 correspond to the first to fourth sections, the trained models A 521, B 523, C 525, and D 527 corresponding to the first to fourth sections included in the route may be identified among the plurality of trained models stored in advance based on the route.

In this case, possibility values regarding the object A and the object B may be obtained by using the image 510 captured in the first section as input data of the trained model A 521 corresponding to the first section.

An object having a higher possibility value among the possibility values regarding the object A and the object B may be identified as a reference object having highest discrimination among the object A and the object B included in the image 510, and a determination result 530 regarding the reference object may be obtained.

In another embodiment, it is assumed that the trained model A 521 corresponds to the first section and a short user, the trained model B 523 corresponds to the first section and a user having color weakness, the trained model C 525 corresponds to the first section and night time, and the trained model D 527 corresponds to the first section and rainy weather.

In this case, the plurality of trained models A 521, B 523, C 525, and D 527 corresponding to the first section included in the route and the environment information may be identified among the plurality of trained models stored in advance based on the image 510 captured in the first section and the environment information (case where a user of the vehicle is short and has color weakness and it rains at night).

Possibility values regarding the object A and the object B may be obtained by using the image 510 captured in the first section as input data of the plurality of trained models A 521, B 523, C 525, and D 527 corresponding to the first section.

In this case, an object having a highest possibility value among the eight possibility values may be identified as a reference object having highest discrimination among the object A and the object B included in the image 510, and the determination result 530 regarding the reference object may be obtained.

However, this is merely an embodiment. The embodiment may be executed after modification in various methods by comparing numbers of objects having the highest values for each of the plurality of trained models and determining an object with the largest number as the reference object, or by applying different weights (or factors) to each of the plurality of trained models A 521, A 523, C 525, and D 527 and comparing values obtained by multiplying the weights (or factors) by the output possibility values regarding the object A and the object B.

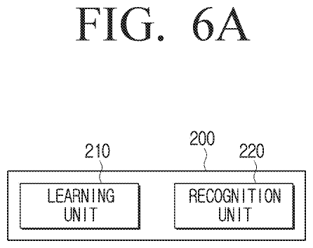

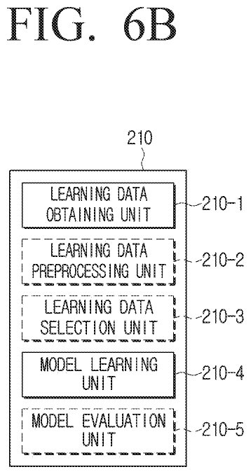

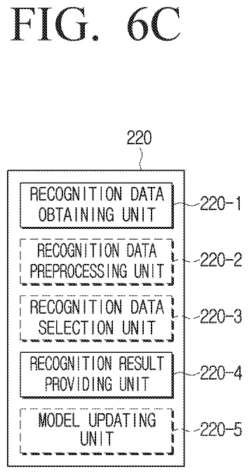

FIGS. 6A, 6B, and 6C are block diagrams showing a learning unit and a recognition unit according to various embodiments of the disclosure.

Referring to FIG. 6A, the server 200 may include at least one of a learning unit 210 and a recognition unit 220.

The learning unit 210 may generate or train a model having determination criteria for determining an object having highest discrimination among a plurality of objects included in an image or the model.

As an example, the learning unit 210 may train the model having determination criteria for determining an object having highest discrimination among a plurality of objects included in an image or update using learning data (e.g., an image obtained by imaging a portion ahead of a vehicle, location information, result information obtained by determining regarding an object having highest discrimination among a plurality of objects included in an image).

The recognition unit 220 may assume the objects included in the image by using image and data corresponding to the image as input data of the trained model.

As an example, the recognition unit 220 may obtain (or assume or presume) a possibility value showing discrimination of the object by using a feature value regarding at least one object included in the image as input data of the trained model.

At least a part of the learning unit 210 and at least a part of the recognition unit 220 may be implemented as a software module, or produced in a form of at least one hardware chip and mounted on an electronic apparatus. For example, at least one of the learning unit 210 and the recognition unit 220 may be produced in a form of hardware chip dedicated for artificial intelligence (AI), or may be produced as a part of a well-known general-purpose processor (e.g., a CPU or an application processor) or a graphics processor (e.g., graphics processing unit (GPU)) and mounted on various electronic apparatuses described above or an object recognition device. The hardware chip dedicated for artificial intelligence is a dedicated processor specialized in possibility calculation and may rapidly process a calculation operation in an artificial intelligence field such as machine running due to higher parallel processing performance than that of the well-known general-purpose processor. In a case where the learning unit 210 and the recognition unit 220 are implemented as a software module (or program module including instructions), the software module may be stored in a non-transitory computer readable media. In this case, the software module may be provided by an operating system (OS) or provided by a predetermined application. In addition, a part of the software module may be provided by an operating system (OS) and the other part thereof may be provided by a predetermined application.

In this case, the learning unit 210 and the recognition unit 220 may be mounted on one electronic apparatus or may be respectively mounted on separate electronic apparatuses. For example, one of the learning unit 210 and the recognition unit 220 may be included in the electronic apparatus 100 of the disclosure and the other one may be included in an external server. In addition, the learning unit 210 and the recognition unit 220 may execute communication in wired or wireless system, to provide model information constructed by the learning unit 210 to the recognition unit 220 and provide data input to the recognition unit 220 to the learning unit 210 as additional learning data.

Referring to FIG. 6B, the learning unit 210 according to an embodiment may include a learning data obtaining unit 210-1 and a model learning unit 210-4. In addition, the learning unit 210 may further selectively include at least one of a learning data preprocessing unit 210-2, a learning data selection unit 210-3, and a model evaluation unit 210-5.

The learning data obtaining unit 210-1 may obtain learning data necessary for models for determining discrimination of objects included in an image. In an embodiment of this document, the learning data obtaining unit 210-1 may obtain at least one of the entire image including objects, an image corresponding to an object region, information regarding objects, and context information as the learning data. The learning data may be data collected or tested by the learning unit 210 or a manufacturer of the learning unit 210.

The model learning unit 210-4 may train a model to have determination criteria regarding determination of objects included in an image using the learning data. As an example, the model learning unit 210-4 may train a classification model through supervised learning using at least a part of the learning data as determination criteria. In addition, the model learning unit 210-4, for example, may train a classification model through unsupervised learning given a set of data that does not have the right answer for a particular input, by self-learning using the learning data without particular supervision. In addition, the model learning unit 210-4, for example, may train a classification model through reinforcement learning using feedback showing whether or not a result of the determination of the situation according to the learning is correct.

In addition, the model learning unit 210-4, for example, may train a classification model using a learning algorithm or the like including an error back-propagation or gradient descent. Further, the model learning unit 210-4 may also train a classification model selection criteria for determining learning data to be used, in order to determine discrimination regarding the objects included in the image using the input data.

When the model is trained, the model learning unit 210-4 may store the trained model. In this case, the model learning unit 210-4 may store the trained model in a memory (not shown) of the server 200 or a memory 160 of the electronic apparatus 100 connected to the server 200 through a wired or wireless network.

The learning unit 210 may further include a learning data preprocessing unit 210-2 and a learning data selection unit 210-3, in order to improve an analysis result of a classification model or save resources or time necessary for generating the classification model.

The learning data preprocessing unit 210-2 may preprocess the obtained data so that the obtained data is used for the learning for determination of situations. The learning data preprocessing unit 210-2 may process the obtained data in a predetermined format so that the model learning unit 210-4 uses the obtained data for learning for determination of situations.

The learning data selection unit 210-3 may select data necessary for learning from the data obtained by the learning data obtaining unit 210-1 or the data preprocessed by the learning data preprocessing unit 210-2. The selected learning data may be provided to the model learning unit 210-4. The learning data selection unit 210-3 may select learning data necessary for learning from the pieces of data obtained or preprocessed, according to predetermined selection criteria. In addition, the learning data selection unit 210-3 may select the learning data according to the predetermined selection criteria by the learning by the model learning unit 210-4.

The learning unit 210 may further include a model evaluation unit 210-5 in order to improve an analysis result of a data classification model.

The model evaluation unit 210-5 may input evaluation data to the models and cause the model learning unit 210-4 to perform the training again, in a case where an analysis result output from the evaluation data does not satisfy a predetermined level. In this case, the evaluation data may be a data predefined for evaluating the models.

For example, when the number of pieces of evaluation data having an incorrect analysis result or a ratio thereof, among the analysis results of the trained classification model with respect to the evaluation data, exceeds a predetermined threshold, the model evaluation unit 210-5 may evaluate that the predetermined level is not satisfied.

In a case of the plurality of trained classification models, the model evaluation unit 210-5 may evaluate whether or not each of the trained classification models satisfies the predetermined level and determine the model satisfying the predetermined level as a final classification model. In this case, in a case where the number of models satisfying the predetermined level is more than one, the model evaluation unit 210-5 may determine any one of or the predetermined number of models set in the order of higher evaluation point in advance as the final classification models.

Referring to FIG. 6C, the recognition unit 220 according to an embodiment may include a recognition data obtaining unit 220-1 and a recognition result providing unit 220-4.

In addition, the recognition unit 220 may further selectively include at least one of a recognition data preprocessing unit 220-2, a recognition data selection unit 220-3, and a model updating unit 220-5.

The recognition data obtaining unit 220-1 may obtain data necessary for determination of situations. The recognition result providing unit 220-4 may determine a situation by applying the data obtained by the recognition data obtaining unit 220-1 to the trained classification model as an input value. The recognition result providing unit 220-4 may provide an analysis result according to an analysis purpose of the data. The recognition result providing unit 220-4 may obtain an analysis result by applying the data selected by the recognition data preprocessing unit 220-2 or the recognition data selection unit 220-3 which will be described later to the model as an input value. The analysis result may be determined by the model.

The recognition unit 220 may further include the recognition data preprocessing unit 220-2 and the recognition data selection unit 220-3, in order to improve an analysis result of a classification model or save resources or time necessary for providing the analysis result.

The recognition data preprocessing unit 220-2 may preprocess the obtained data so that the obtained data is used for determination of situations. The recognition data preprocessing unit 220-2 may process the obtained data in a predetermined format so that the recognition result providing unit 220-4 uses the obtained data for determination of situations.

The recognition data selection unit 220-3 may select data necessary for determination of situations from the data obtained by the recognition data obtaining unit 220-1 and the data preprocessed by the recognition data preprocessing unit 220-2. The selected data may be provided to the recognition result providing unit 220-4. The recognition data selection unit 220-3 may select some or all of the pieces of data obtained or preprocessed, according to predetermined selection criteria for determination situations. In addition, the recognition data selection unit 220-3 may select data according to the selection criteria predetermined by the learning by the model learning unit 210-4.

The model updating unit 220-5 may control the trained model to be updated based on an evaluation of the analysis result provided by the recognition result providing unit 220-4. For example, the model updating unit 220-5 may provide the analysis result provided by the recognition result providing unit 220-4 to the model learning unit 210-4 to request the model learning unit 210-4 to additionally train or update the trained model.

The server 200 may further include a processor (not shown), and the processor may control overall operations of the server 200 and may include the learning unit 210 or the recognition unit 220 described above.

In addition to this, the server 200 may further include one or more of a communication interface (not shown), a memory (not shown), a processor (not shown), and an output interface. For these, a description of a configuration of the electronic apparatus 100 of FIG. 7 may be applied in the same manner. The description regarding the configuration of the server 200 is overlapped with the description regarding the configuration of the electronic apparatus 100, and therefore, the description thereof is omitted. Hereinafter, the configuration of the electronic apparatus 100 will be described in detail.

FIG. 7 is a block diagram specifically showing a configuration of an electronic apparatus according to an embodiment of the disclosure.

Referring to FIG. 7, the electronic apparatus 100 may further include one or more of the communication interface 150, the memory 160, and an input interface 170, in addition to the camera 110, the sensor 120, the output interface 130, and the processor 140.

The processor 140 may include a RAM 141, a ROM 142, a graphics processing unit 143, a main CPU 144, a first to n-th interfaces 145-1 to 145-n, and a bus 146. The RAM 141, the ROM 142, the graphics processing unit 143, the main CPU 144, and the first to n-th interfaces 145-1 to 145-n may be connected to each other via the bus 146.

The communication interface 150 may transmit and receive various types of data by executing communication with various types of external device according to various types of communication system. The communication interface 150 may include at least one of a Bluetooth chip 151, a Wi-Fi chip 152, a wireless communication chip 153, and an near field communication (NFC) chip 154 for executing wireless communication, and an Ethernet module (not shown) and a universal serial bus (USB) module (not shown) for executing wired communication. In this case, the Ethernet module (not shown) and the USB module (not shown) for executing wired communication may execute the communication with an external device through an input and output port (not shown).

The memory 160 may store various instructions, programs, or data necessary for the operations of the electronic apparatus 100 or the processor 140. For example, the memory 160 may store the image obtained by the camera 110, the location information obtained by the sensor 120, and the trained model or data received from the server 200.

The memory 160 may be implemented as a non-volatile memory, a volatile memory, a flash memory, a hard disk drive (HDD), or a solid-state drive (SSD). The memory 160 may be accessed by the processor 140 and reading, recording, editing, deleting, or updating of the data by the processor 140 may be executed. A term memory in the disclosure may include the memory 160, the random access memory (RAM) 141 and the read only memory (ROM) 142 in the processor 140, or a memory card (not shown) (for example, a micro secure digital (SD) card or memory stick) mounted on the electronic apparatus 100.

The input interface 170 may receive various types of user command and transmit the user command to the processor 140. That is, the processor 140 may set a destination according to various types of user command received through the input interface 170.

The input interface 170 may include, for example, a touch panel, a (digital) pen sensor, or keys. In the touch panel, at least one type of a capacitive type, a pressure sensitive type, an infrared type, and an ultrasonic type may be used. In addition, the touch panel may further include a control circuit. The touch panel may further include a tactile layer and provide a user a tactile reaction. The (digital) pen sensor may be, for example, a part of the touch panel or may include a separate sheet for recognition. The keys may include, for example, physical buttons, optical keys or a keypad. In addition, the input interface 170 may be connected to an external device (not shown) such as a keyboard or a mouse in a wired or wireless manner to receive a user input.

The input interface 170 may include a microphone capable of receiving voice of a user. The microphone may be embedded in the electronic apparatus 100 or may be implemented as an external device and connected to the electronic apparatus 100 in a wired or wireless manner. The microphone may directly receive voice of a user and obtain an audio signal by converting the voice of a user which is an analog signal into a digital signal by a digital conversion unit (not shown).

The electronic apparatus 100 may further include an input and output port (not shown).

The input and output port have a configuration of connecting the electronic apparatus 100 to an external device (not shown) in a wired manner so that the electronic apparatus 100 may transmit and/or receive an image and/or a signal regarding voice to and from the external device (not shown).

For this, the input and output port may be implemented as a wired port such as a high definition multimedia interface (HDMI) port, a display port, a red, green, and blue (RGB) port, a digital visual interface (DVI) port, a Thunderbolt port, a USB port, and a component port.

As an example, the electronic apparatus 100 may receive an image and/or a signal regarding voice from an external device (not shown) through the input and output port so that the electronic apparatus 100 may output the image and/or the voice. As another example, the electronic apparatus 100 may transmit a particular image and/or signal regarding voice to an external device through an input and output port (not shown) so that an external device (not shown) may output the image and/or the voice.

As described above, the image and/or the signal regarding voice may be transmitted in one direction through the input and output port. However, this is merely an embodiment, and the image and/or the signal regarding voice may be transmitted in both directions through the input and output port.

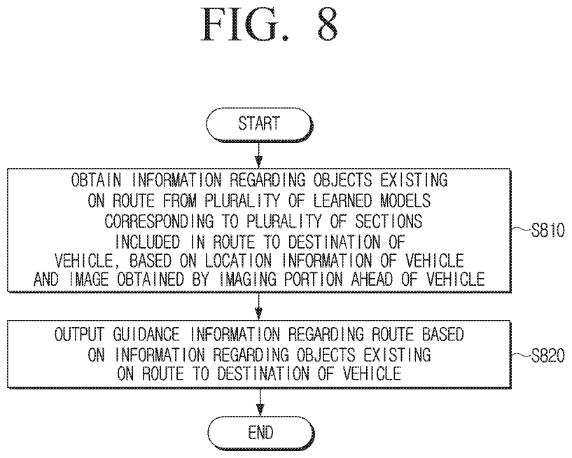

FIG. 8 is a diagram for describing a flowchart according to an embodiment of the disclosure.

Referring to FIG. 8, a controlling method of the electronic apparatus 100 included in a vehicle according to an embodiment of the disclosure may include, based on location information of the vehicle and an image obtained by imaging a portion ahead of the vehicle, obtaining information regarding objects existing on a route from a plurality of trained models corresponding to a plurality of sections included in the route to a destination of the vehicle, and based on information regarding objects existing on the route to the destination of the vehicle, outputting guidance information regarding the route.

Specifically, first, information regarding objects existing on a route may be obtained from a plurality of trained models corresponding to a plurality of sections included in the route to a destination of a vehicle, based on location information of the vehicle and an image obtained by imaging a portion ahead of the vehicle at operation S810. Here, the objects may include buildings existing on the route.

Each of the plurality of trained models may include a model trained to determine an object having highest possibility to be discriminated at a particular location among the plurality of objects included in the image, based on the image captured at the particular location. Each of the plurality of trained models may include a model trained based on an image captured in each of the plurality of sections of the route divided with respect to intersections. In addition, the plurality of sections may be divided with respect to the intersections existing on the route.

Next, the guidance information regarding the route may be output based on the information regarding objects existing on the route to the destination of the vehicle at operation S820. In this case, the guidance information regarding at least one of a travelling direction and a travelling distance of the vehicle may be output based on the buildings. In addition, in the outputting, the guidance information may be output through at least one of a speaker and a display.

According to an embodiment of the disclosure, the outputting may further include transmitting information regarding a route, the location information of the vehicle, and the image obtained by imaging a portion ahead of the vehicle to the server 200, and receiving the guidance information from the server 200 and outputting the guidance information.

Specifically, the information regarding a route, the location information of the vehicle, and the image obtained by imaging a portion ahead of the vehicle may be transmitted to the server 200. In this case, the server 200 may determine the plurality of trained models corresponding to the plurality of sections included in the route among trained models stored in advance, obtain information regarding objects by using the image as input data of the trained model corresponding to the location information of the vehicle among the plurality of trained models, and obtain the guidance information based on the information regarding objects. The guidance information regarding a route may be received from the server 200 and the guidance information regarding a route may be output.

According to an embodiment of the disclosure, in the outputting of the disclosure, the information regarding a route may be transmitted to the server 200, the plurality of trained models corresponding to the plurality of sections included in the route may be received from the server 200, and the information regarding objects may be obtained by using the image as input data of the trained model corresponding to the location information of the vehicle among the plurality of trained models.

Specifically, the information regarding a route may be transmitted to the server 200. In this case, the plurality of trained models corresponding to the plurality of sections included in the route may be transmitted from the server, and the information regarding objects may be obtained by using the image as input data of the trained model corresponding to the location information of the vehicle among the plurality of trained models. The guidance information regarding a route may be output based on the information regarding objects.

Various embodiments of the disclosure may be implemented as software including instructions stored in machine (e.g., computer)-readable storage media. The machine herein is an apparatus which invokes instructions stored in the storage medium and is operated according to the invoked instructions, and may include an electronic apparatus (e.g., electronic apparatus 100) according to the disclosed embodiments. In a case where the instruction is executed by a processor, the processor may execute a function corresponding to the instruction directly or using other elements under the control of the processor. The instruction may include a code generated by a compiler or executed by an interpreter. The machine-readable storage medium may be provided in a form of a non-transitory storage medium. Here, the term “non-transitory” merely mean that the storage medium is tangible while not including signals, and it does not distinguish that data is semi-permanently or temporarily stored in the storage medium.

The methods according to various embodiments of the disclosure may be provided to be included in a computer program product. The computer program product may be exchanged between a seller and a purchaser as a commercially available product. The computer program product may be distributed in the form of a machine-readable storage medium (e.g., compact disc read only memory (CD-ROM) or distributed online through an application store (e.g., PlayStore™). In a case of the on-line distribution, at least a part of the computer program product may be temporarily stored or temporarily generated at least in a storage medium such as a memory of a server of a manufacturer, a server of an application store, or a relay server.

Each of the elements (for example, a module or a program) according to various embodiments may be composed of a single entity or a plurality of entities, and some sub-elements of the abovementioned sub-elements may be omitted. The elements may be further included in various embodiments. Alternatively or additionally, some elements (e.g., modules or programs) may be integrated into one entity to perform the same or similar functions performed by each respective element prior to integration. Operations performed by a module, a program, or other elements, in accordance with various embodiments, may be performed sequentially, in a parallel, repetitive, or heuristically manner, or at least some operations may be performed in a different order, omitted, or may add a different operation.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus included in a vehicle, the electronic apparatus comprising:
a camera;
a sensor;
an output interface comprising circuitry; and
a processor configured to, based on information regarding objects existing on a route to a destination of the vehicle, output guidance information regarding the route through the output interface,
wherein the information regarding objects is obtained from a plurality of trained models corresponding to a plurality of sections included in the route based on location information of the vehicle obtained through the sensor and an image obtained by imaging a portion ahead of the vehicle obtained through the camera.

2. The electronic apparatus according to claim 1,
wherein the objects comprise buildings existing on the route, and
wherein the processor is further configured to output the guidance information regarding at least one of a travelling direction or a travelling distance of the vehicle based on the buildings.

3. The electronic apparatus according to claim 1, wherein each of the plurality of trained models is a model trained to determine an object having highest possibility to be discriminated at a particular location among a plurality of objects included in the image, based on the image captured at the particular location.

4. The electronic apparatus according to claim 3, wherein each of the plurality of trained models is a model trained based on an image captured in each of the plurality of sections of the route divided with respect to intersections.

5. The electronic apparatus according to claim 1, wherein the plurality of sections are divided with respect to intersections existing on the route.

6. The electronic apparatus according to claim 1, further comprising:
a communication interface comprising circuitry,
wherein the processor is further configured to:
control the communication interface to transmit, to a server, information regarding the route, the location information of the vehicle obtained through the sensor, and the image obtained by imaging a portion ahead of the vehicle obtained through the camera, and
based on the guidance information being received from the server via the communication interface, output the guidance information through the output interface, and
wherein the server is configured to:
identify a plurality of trained models corresponding to the plurality of sections included in the route among trained models stored in advance,
obtain the information regarding objects by using the image as input data of a trained model corresponding to the location information of the vehicle among the plurality of trained models, and
obtain the guidance information based on the information regarding objects.

7. The electronic apparatus according to claim 1, further comprising:
a communication interface comprising circuitry,
wherein the processor is further configured to:
control the communication interface to transmit information regarding the route to a server, and
based on a plurality of trained models corresponding to the plurality of sections included in the route being received from the server via the communication interface, obtain the information regarding objects by using the image as input data of a trained model corresponding to the location information of the vehicle among the plurality of trained models.

8. The electronic apparatus according to claim 1,
wherein the output interface includes at least one of a speaker or a display, and
wherein the processor is further configured to output the guidance information through at least one of the speaker or the display.

9. A controlling method of an electronic apparatus included in a vehicle, the controlling method comprising:
obtaining information regarding objects existing on a route from a plurality of trained models corresponding to a plurality of sections included in the route to a destination of the vehicle based on location information of the vehicle and an image obtained by imaging a portion ahead of the vehicle; and
outputting guidance information regarding the route based on the information regarding the objects existing on the route to the destination of the vehicle.

10. The controlling method according to claim 9,
wherein the objects include buildings existing on the route, and
wherein the outputting comprises outputting the guidance information regarding at least one of a travelling direction or a travelling distance of the vehicle based on the buildings.

11. The controlling method according to claim 9, wherein each of the plurality of trained models is a model trained to identify an object having highest possibility to be discriminated at a particular location among a plurality of objects included in the image, based on the image captured at the particular location.

12. The controlling method according to claim 11, wherein each of the plurality of trained models is a model trained based on an image captured in each of the plurality of sections of the route divided with respect to intersections.

13. The controlling method according to claim 9, wherein the plurality of sections are divided with respect to intersections existing on the route.

14. The controlling method according to claim 9,
wherein the outputting further comprises:
transmitting information regarding the route, the location information of the vehicle, and the image obtained by imaging a portion ahead of the vehicle to a server, and
receiving the guidance information from the server and outputting the guidance information,
wherein the server is configured to:
identify a plurality of trained models corresponding to the plurality of sections included in the route among trained models stored in advance,
obtains the information regarding objects by using the image as input data of a trained model corresponding to the location information of the vehicle among the plurality of trained models, and
obtains the guidance information based on the information regarding objects.

15. The controlling method according to claim 9, wherein the outputting comprises transmitting information regarding the route to a server, receiving a plurality of trained models corresponding to the plurality of sections included in the route from the server, and obtains the information regarding objects by using the image as input data of a trained model corresponding to the location information of the vehicle among the plurality of trained models.

16. The controlling method according to claim 9, wherein the outputting comprises outputting the guidance information through at least one of a speaker or a display.
